(19) United States
(12) Patent Application Publication
(10) Pub. No.: US 2026/0087045 A1
(43) Pub. Date: Mar. 26, 2026

(54) DYNAMIC AI SYSTEM FOR CONTEXT-AWARE, DOMAIN-SPECIFIC WORKFLOW MANAGEMENT

(71) Applicant: CELLIGENCE INTERNATIONAL LLC, Guaynabo, PR (US)

(72) Inventors: Pavan AGARWAL, DORADO, PR (US); Gabriel Albors SANCHEZ, SAN JUAN, PR (US); Jonathan Ortiz RIVERA, SAN JUAN, PR (US); Dennis J. BORRERO, SAN JUAN, PR (US); Arindam BRAHMA, ALISO VIEJO, CA (US)

(73) Assignee: CELLIGENCE INTERNATIONAL LLC, Guaynabo, PR (US)

(21) Appl. No.: 19/339,154

(22) Filed: Sep. 24, 2025

Related U.S. Application Data
(60) Provisional application No. 63/699,760, filed on Sep. 26, 2024.

(51) Int. Cl. G06F 16/3329; G06F 40/30

(52) U.S. Cl. CPC G06F 16/33295; G06F 40/30

(57) ABSTRACT

A system is disclosed for generating context-aware, domain-specific responses using a pre-trained language model in combination with a semantic search engine and specialized processing modules. The system includes a classification model to identify user intent, an extraction model to determine parameters, and a plurality of parameter functions that generate outputs such as sentiment classifications, semantically similar content, and dynamically constructed prompts. By integrating retrieved structured and unstructured content into tailored prompts, the system provides accurate, domain-specific query responses without requiring retraining of the underlying language model. The architecture supports efficient and scalable workflow management in dynamic environments while reducing computational overhead compared to conventional approaches.

### RELATED APPLICATIONS

This application claims the benefit of U.S. Provisional Application No. 63/699,760 filed on Sep. 26, 2024, the entirety of which is incorporated herein by reference.

### FIELD OF INVENTION

The present disclosure relates generally to artificial intelligence and natural language processing, and more particularly to systems and methods for dynamically generating and managing context-aware, domain-specific workflows in response to user queries.

### BACKGROUND

LLM (Large Language Model) is a specific type of Neural Language Model (NLM) within the field of Natural Language Processing (NLP) that leverages large datasets and complex neural networks to perform sophisticated language tasks (both in terms of the number of parameters and the volume of training data). LLMs are typically deep learning models that have been trained on extensive corpora to perform a wide range of NLP tasks. A trained model will periodically need to be re-trained to update or refine its knowledge based on new data, adjust to domain-specific tasks, or correct its performance. Thus, model's ability to continuously performs with high level of accuracy (i.e., the proportion of correctly predicted instances (both true positives and true negatives out of the total number of instances), precision (i.e., the proportion of true positive predictions out of all the positive predictions made by the model), and/or other similar metrics, depends on large amounts of computing resources.

The disclosed system overcomes these limitations by integrating multiple components into a flexible and dynamic architecture, enabling efficient, real-time interaction with minimal computational requirements.

### SUMMARY

In accordance with one or more embodiments, the disclosed system comprises a dynamic AI architecture that leverages a pre-trained language model in conjunction with a procedural function management framework, semantic search engine, and content retrieval modules. The system provides accurate, context-aware, workflow-based responses to user queries without requiring the resource-intensive retraining typically associated with domain-specific applications of large language models. By dynamically constructing and executing functions and prompts, the system achieves efficient use of computing resources while maintaining scalability and adaptability to new tasks and data.

Various features and functionality can be provided by the context-aware, domain-specific workflow-based response and sentiment analysis system. The system may include a chat interface for receiving user queries, a query-and-response (Q&R) endpoint application programming interface (API) configured to handle workflow-based responses, and a sentiment predictor API configured to analyze user sentiment. The conversation engine may include a classification model for determining user intent, an extraction model for identifying parameters or entities associated with the intent, and a procedural function engine for dynamically generating and managing procedural functions. The procedural functions may include sentiment prediction and workflow-based response generation (e.g., via a sentiment prediction engine), coordinating content retrieval and language model activation (e.g., via a chat orchestrator engine), retrieving content (e.g., via an augmenting content retriever accessing an augmenting content store), and constructing prompts for the language model (e.g., via a dynamic augmented prompt builder).

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1A illustrates a network including a context-aware, domain-specific system for generating workflow-based responses, according to an implementation of the disclosure.

FIG. 1B illustrates a schematic diagram of a procedural function framework of the system of FIG. 1A, according to an implementation of the disclosure.

FIG. 2 illustrates a process flow of a conversation engine of the context-aware, domain-specific system of FIG. 1A, according to an implementation of the disclosure.

FIGS. 3A-3C illustrate exemplary chat-based user interface embodiments of the context-aware, domain-specific system for generating workflow-based responses, according to an implementation of the disclosure.

FIGS. 4A-4B illustrate exemplary chat-based user interface embodiments of the system showing auto-detection of responses and placement of the responses into the correct sequence, according to an implementation of the disclosure.

FIG. 5 illustrates an example computing system that may be used in implementing various features of embodiments of the disclosed technology.

The figures collectively illustrate systems and methods for context-aware, domain-specific query answering and sentiment analysis. As shown in the accompanying drawings, embodiments of the disclosure provide technical improvements in workflow orchestration, intent classification, parameter extraction, sentiment analysis, and content retrieval, enabling efficient and scalable workflow management without the computational overhead and retraining requirements of conventional systems. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

Presently disclosed system includes a conversation engine with a flexible and dynamic AI architecture designed to handle complex user queries in real-time with a high level of accuracy, while minimizing the computational resources typically required by traditional GPU-intensive Large Language Models (LLMs). Unlike traditional NLP models that demand significant computing power for training on specific datasets, the present system is lightweight and uses minimal CPU and GPU resources. This efficiency is achieved through its dynamic workflow-based response generation approach rather than relying on a pre-trained single-purpose model.

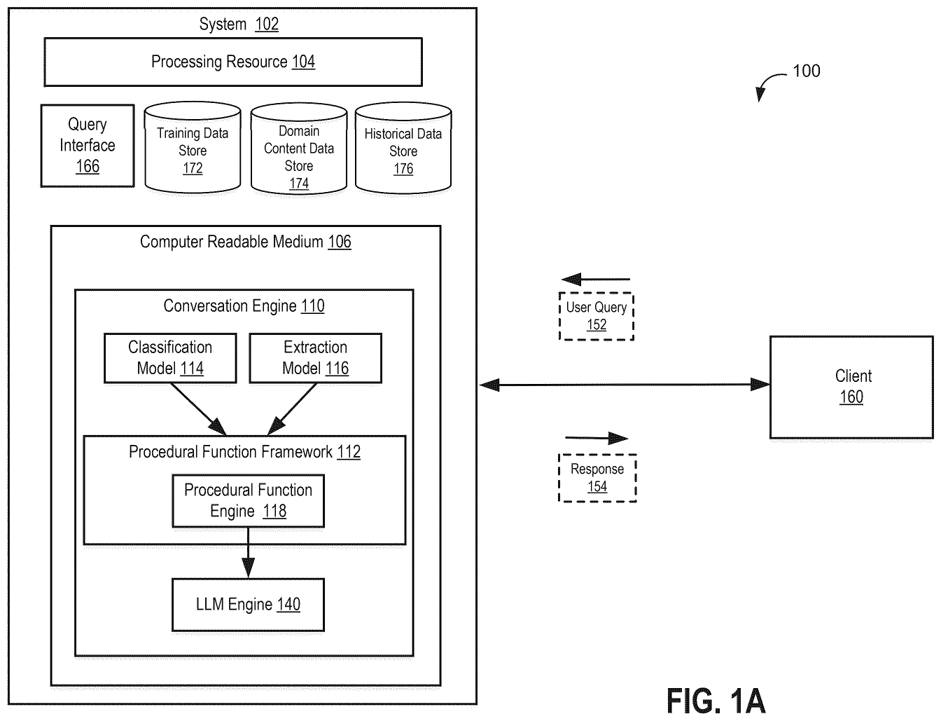

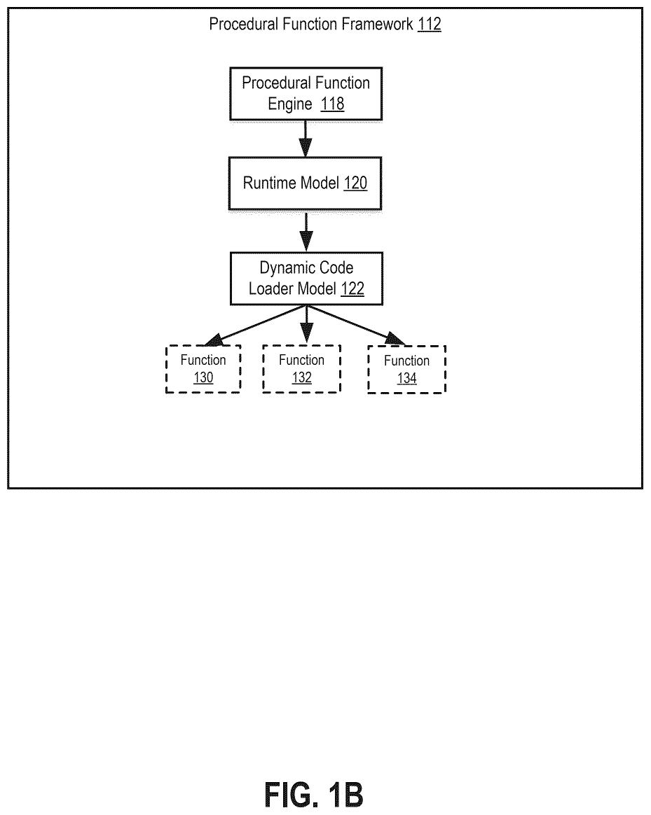

In one embodiment, the disclosed system utilizes the conversation engine 110 of FIG. 1A to dynamically generate and manage complex workflows. A workflow is a series of activities that are necessary to complete a task. Each step in a workflow has a specific preceding step and leads to a subsequent one, with the exception of the first step. For example, determining the approval of a mortgage loan requires the user to provide certain information in a particular sequence. In this case, a workflow may include a series of automatically generated questions related to the mortgage loan approval process. These questions are designed to elicit user responses that complete specific categories or phases of the process. For example, in a mortgage loan approval workflow, questions might ask for the user's age, income, property address, and other relevant information. Workflows can include individual or grouped sets of questions based on particular sub-processes. These workflows are typically associated with a workflow interface. Some workflows may require users to input detailed data, while others may present simpler options, such as “Yes” or “No” prompts, depending on the task at hand.

This conversation engine 110 leverages both the classification model 114 and extraction model 116 to understand user requests, determine appropriate workflows, guide the user through each step of the workflow, and handle multiple workflows in parallel or sequentially, as needed.

The conversation engine 110 can also pause and resume workflows based on user input, ensuring seamless navigation and task completion.

This embodiment demonstrates the system's capability to dynamically generate workflows based on user intent and guide the user through each step, while also managing multiple workflows in parallel or sequentially as needed. By leveraging the conversation engine 110 to dynamically generate procedural functions through the procedural function engine 118, and by utilizing the classification model 114 and extraction model 116, the system 102 ensures seamless and efficient navigation through complex workflows, improving overall user experience and operational efficiency.

The system dynamically generates and manages workflows in response to user intents, allowing for highly customized interactions and efficient data collection processes. The ability to handle multiple workflows simultaneously, pausing and resuming as needed, enhances the user experience by allowing users to multitask or address different needs without starting over or losing progress. By guiding users step-by-step through complex workflows and ensuring all necessary information is collected in a logical sequence, the system reduces the cognitive load on users, making interactions simpler and more intuitive. The system's ability to dynamically generate workflows based on user intents and adaptively ask questions ensures that it remains flexible and responsive to changing user needs, preferences, and behaviors. The dynamic nature of the workflow generation and management, guided by a well-trained LLM, eliminates the need for frequent retraining. The system remains accurate and effective over time, as it relies on real-time content retrieval and context management rather than fixed domain-specific training.

The present system combines several interconnected components to dynamically create procedural functions, handle multiple datasets, and integrate with external systems, providing more contextually appropriate and tailored workflow-based responses. In particular, the system includes: (i) classification and extraction models for intent (action triggers) and entity (parameter) recognition, embedded within a procedural function management framework, (ii) a sentiment analysis model, that detects user sentiment in real time without requiring retraining, (iii) a semantic search engine that retrieves semantically relevant content from a pre-stored domain-specific repository, and (iv) a content retrieval and content augmentation tools that dynamically construct prompts for the LLM based on user queries and domain-specific content.

These components work cohesively to interpret user input, execute appropriate actions, and generate accurate, context-aware responses. By embedding classification and extraction models—common to Natural Language Understanding (NLU) but not typically found in Natural Language Processing (NLP)—within a procedural function framework, the system achieves contextual accuracy with a lightweight, pre-trained LLM, rather than relying on the GPU-intensive models used in traditional NLP frameworks.

The system introduces several technical improvements, including enhanced scalability and adaptability. It can grow and evolve by dynamically generating new functions as needed, allowing it to handle new tasks or datasets without the need for retraining the entire model from scratch. Additionally, it can integrate new data sources and accommodate various business scenarios with minimal additional effort, providing a robust and versatile solution for domain-specific applications.

### Conventional System Limitations

Conventional workflow systems and conversational agents suffer from several limitations. First, traditional workflow engines typically rely on pre-defined, rigid scripts or decision trees. Such designs lack adaptability and cannot seamlessly adjust to unexpected user input, incomplete responses, or parallel tasks. Once a workflow is interrupted, users often must restart the entire process, creating inefficiency and poor user experience.

Second, existing chatbot systems generally embed domain-specific knowledge directly into a model or rely on keyword-based triggers. This approach necessitates frequent and resource-intensive retraining whenever business rules, products, or regulatory requirements change.

Third, conventional systems usually store entire workflow states in memory or session databases, requiring significant storage resources, introducing synchronization complexity, and limiting scalability across distributed environments.

Fourth, most prior workflow engines do not leverage hybrid synchronous/asynchronous orchestration, resulting in bottlenecks, dropped queries, or latency spikes when multiple workflows or content retrieval tasks are processed concurrently.

Finally, conventional workflow systems are prone to model drift as domain-specific data evolves, reducing accuracy and requiring continuous retraining or manual updates.

### Technical Improvements

The disclosed embodiments provide technical improvements that overcome these limitations. By embedding classification and extraction models within a procedural function framework, the system dynamically generates and executes workflow steps in response to user intents without relying on static scripts. This dynamic workflow generation allows tasks such as loan qualification, credit card application, or reservation scheduling to adapt in real-time to incomplete, changing, or parallel user input. Unlike conventional systems that require retraining, the present architecture decouples domain-specific content from the pre-trained language model. Relevant content is dynamically retrieved at runtime using a semantic search engine and augmenting content retriever, thereby reducing model drift and eliminating costly retraining cycles.

The system further incorporates a stateless workflow design in which only minimal metadata (e.g., sequence identifiers) is persisted, enabling seamless pause/resume functionality while minimizing memory and storage demands. This stateless approach improves scalability in cloud and distributed environments by simplifying state management and reducing synchronization overhead.

Additionally, hybrid synchronous and asynchronous orchestration ensures that latency-sensitive tasks (such as prompt construction and LLM response generation) are executed sequentially, while resource-intensive tasks (such as sentiment analysis or content retrieval) run concurrently. This combination provides improved throughput, lower latency, and more reliable real-time interactions compared to prior systems. Overall, the disclosed system delivers more efficient, scalable, and resilient workflow management than conventional NLP-driven or rule-based platforms.

FIG. 1A illustrates an example network 100 including a system 102 and a client computing device 160. The system 102 receives a query 152 from a client 160 over the network 100. In some examples, the network 100 is a distributed network where the system 102 and client 160 are located at physically different locations (e.g., on different racks, on different enclosures, in different buildings, in different cities, in different countries, and the like) while being connected via the network 100. In other examples, any combination of the system 102 and the client may be co-located, including running as separate virtual devices on the same physical device.

In FIG. 1A, although the network 100 is shown to include one system 102 and a client 160, the network 100 may include any number of systems and clients, without limiting the scope of the present disclosure. The system 102 is a heterogeneous computing system including an example processing resource 104 and an example machine-readable medium 106. The processing resource 104 may include different types of processing units (also referred to as service provider resources), such as Central Processing Unit (CPU), Graphical Processing Unit (GPU), and the like. The machine-readable medium 106 includes memory resources (e.g., cache memory), storage resources (e.g., non-volatile storage devices), and the like. The machine readable medium 106 stores conversation engine 110.

The conversation engine 110 is executable by the processing resource 106 to determine response(s) to the queries 152 using a classification model 114 and extraction model 116 which is integrated with a procedural function framework 112 that includes a procedural function engine 118, and a pre-trained LLM 120. Training data may be stored in a training store 172. Domain-specific content data including both structured data stored in databases (e.g., customer records, product information, transaction data, etc.) and unstructured or semi-structured content that is not stored in traditional databases (e.g., documents, reports, manuals, or internal knowledge bases) may be stored in a unified content data store 174. Training data stored in data store 172 may be a subset of the domain-specific content. In some embodiment, training data and domain-specific data may be stored in the same database 172. Data from previous user interactions, such as past queries, generated responses, detected intents, extracted entities, and sentiment analysis results may be stored in a historic data store 176.

In some embodiments, a distributed query application 166 may be operable by processing resource 104 configured to execute machine-readable instructions of machine-readable medium 106 comprising applications, engines, or modules, including computer program components. In some embodiments, the computer program components may include the conversation engine 110 and/or other such components. The corresponding client query application (not illustrated) may be configured to provide client functionality to enable a user to enter queries or questions 152 via a chat-based interface and receive responses 154 to those queries via a user interface provided on client computing device 160.

In some embodiments, client computing device 160 may include a variety of electronic computing devices, such as, for example, a smartphone, tablet, laptop, computer, wearable device, television, virtual reality device, augmented reality device, displays, connected home device, Internet of Things (IOT) device, an enhanced general packet radio service (EGPRS) mobile phone, a media player, a navigation device, a game console, a television, a remote control, or a combination of any two or more of these data processing devices, and/or other devices. In some embodiments, client computing device 160 may present content to user 150 and receive customer message input.

The conversation engine 110 defines a software architecture to execute components on the system 102 for determining a workflow in response to queries, e.g., query 152. Each component may perform an operation for processing query 152. The query 152 may be provided as input to a classification model 114 and extraction model 116 which may in turn provide their input to procedural function framework 112. The procedural function framework 112 which is integrated with the classification model 114 and extraction model 116 may receive the output generated by models 114 and 116 as input via its procedural function engine 118. In some examples, the procedural function framework 112 may include the pre-trained LLM 140. The output of the procedural function framework 112 may include the response 154 to query 152.

In some embodiments, the classification model 114 is configured to identify the user's goal or purpose behind a query or input. In speech processing, detecting the goal or purpose means identifying what the user wants to achieve or communicate with their utterance. The classification model 114 detects and categorizes multiple intents from a given input. The classification model 114 helps in guiding the conversation engine 110 to understand which dataset or function to use to respond appropriately to the user's query. In some embodiment, the classification model 114 provides the first layer of understanding to ensure the system knows the user's objective, which directs the flow of information processing. The classification model 114 uses machine learning algorithms, such as natural language processing (NLP), to analyze text and classify it into predefined categories (e.g., “apply for a loan,” “make a reservation,” “report an issue,” etc.). In some embodiments, the NLP models used for classification tasks in include Logistic Regression (e.g., a model for binary classification tasks), Support Vector Machines (SVMs) (e.g., for separating data into different categories), Neural Networks (e.g., deep learning models like RNNs, Long Short-Term Memory (LSTM) networks, and transformers, which are particularly effective in handling complex language tasks), and other similar models. Once the intent is determined, the procedural function framework 112 uses this information to decide which specific procedural function or set of functions (cells) should be executed to fulfill the user's request.

In some embodiments, the classification model 114 may use supervised learning techniques where it is trained on labeled data. For example, a dataset containing user queries and their corresponding intents is used to train the model. The model 114 learns from this data to predict the correct intent of new, unseen queries. It may also employ advanced NLP techniques, such as transformers or recurrent neural networks (RNNs), to understand the context and nuances of human language. In other words, the model 114 has learned to classify input based on pre-annotated examples. In some embodiments, labeled data may be stored in training data store 172 and include manually labeled or annotated data to indicate the correct user intent (i.e., action that the model should be taking) for specific tasks and to provide explicit examples for the model to learn from. The labeled training data stored in training data store 172 may include a subset of domain-specific content, e.g., stored in data store 174. In other embodiments, training data and domain-specific data may be stored in the same database 172.

Additionally, the labeled data may include a manually labeled micro-intent and an action attribute. The labeled data may be domain-specific and directly tied to a particular task (e.g., obtaining loan-related information). For example, intent identification data may have labels indicating the specific user intent that can be associated with each sentence.

Once the training data has been labeled, it can be used to train the classification model 114 to process labeled user queries to determine user intent.

The classification model 114 learns from the sample data which has been labeled. The more sample data is provided to the model the more accurate the model will be at detecting a particular intent.

In some embodiments, each user query of the labeled data may be broken down into tokens which are tagged with the intent they are associated with. The more user queries (i.e., sentences) are associated with an intent the more accurate the model becomes.

In some embodiments, a weight may be assigned to a query based on the number of tokens. For example, if a sample sentence is broken down into 5 words, then the weight of the sample for that intent is assigned a weight of 5.

The extraction model 116 is used to identify and extract parameters (or entities) from the user's input. Parameters (or entities) are specific pieces of information or data points that provide context or details necessary to complete the action associated with the detected intent (e.g., names, dates, locations, quantities) of the user made by model 114. In speech processing, identifying parameters (or entities) means extracting meaningful and relevant pieces of data from the user's input. The extraction model 116 tags relevant parameters (or entities) in the input text and extracts a set of query parameters associated with the identified query intent. In some embodiments, the extraction model 116 may obtain parameters from a domain-specific database.

The extraction model 116 uses machine learning algorithms, such as natural language processing (NLP), to o recognize and extract these parameters (or entities) from text. In some embodiments, the NLP models used for classification tasks in include Named Entity Recognition (NER): (e.g., a model for binary classification tasks), Conditional Random Fields (CRF) (e.g., a probabilistic model often used for structured prediction, particularly effective for sequence tagging tasks like entity extraction), Neural Networks (e.g., Recurrent Neural Networks (RNNs), Long Short-Term Memory (LSTM) networks, and transformers, which can handle complex patterns in language and context), Named Entity Recognition (NER) Models (e.g., based on machine learning algorithms like CRFs, HMMs (Hidden Markov Models), or deep learning approaches), Transformer-Based Models: Such as BERT (Bidirectional Encoder Representations from Transformers) or GPT (Generative Pre-trained Transformer), which can understand context and extract entities with high accuracy, and other similar models. The extracted parameters (or entities) serve as parameters or arguments for the procedural functions of procedural framework 112 that are executed. The procedural function framework 112 dynamically uses these parameters (or entities) to ensure that the correct data is used in each function.

The extraction model 116 may be trained using supervised learning techniques with labeled datasets, where the training data includes examples of text annotated with the entities that the model needs to recognize. The labeled training data used to train the extraction model 116 is described above, in reference to the classification model 114.

The procedural function framework 112 leverages both the classification model 114 (for detecting intents) the extraction model 116 (for identifying entities) to understand user queries and uses engine 118 which creates and executes procedural functions based on the detected user intent and entities to identify the user's intent. For example, based on the identified intent, engine 118 determines which functions or workflows need to be executed by engine 118 to address the identified intent. In some embodiments, this selection may be based on predefined mappings between detected intents and the available functions. In other embodiments, engine 118, may dynamically determine and generate the functions. Simultaneously, engine 118 utilizes extraction model 116 to pull out relevant entities from the input. These entities provide the necessary details that the functions require to perform the desired task. Together, these models enable the engine 118 to dynamically execute the appropriate functions or workflows needed to fulfill the user's request, making the system flexible, adaptable, and capable of handling diverse tasks in real-time. In some embodiments, engine 118 may act as a central controller or orchestrator that determines which procedural functions should be executed to fulfill the user's request.

In some embodiments, LLM 140 used to produce the final response may comprise a pre-trained LLM developed using an open-source LLM model (OpenChatKit) that uses 7 billion parameters and a Generative Pretrained Transformer (GPT) algorithm.

In some embodiments, procedural function framework 112 may comprise a runtime model, which is a specific component or module within the engine 118. For example, as illustrated in FIG. 1B, Runtime model 120 may be configured to execute the decisions made by the engine 118, particularly concerning which procedural functions to run and how they should be executed, as illustrated in FIG. 1B. Runtime model 120 may handle the real-time execution of procedural functions based on the intent and entity information provided by models 114 and 116, respectively. It serves as the runtime environment where decisions are operationalized-converting the output of the intent and entity detection into specific actions performed by the procedural functions. The runtime model 120 may use a command selector (not illustrated) to determine which procedural functions to execute based on the identified intents and extracted entities.

In some embodiments, runtime model 120 may comprise a dynamic code loader 122 that dynamically loads and executes the required procedural functions 130, 132, 134 based on the decisions made by the runtime model 120, ensuring that the right functions are run at the right time. A configuration file containing the list of all supported intents and the actions associated with them may be used.

Each of the functions 130, 132, 134 is a dynamic, procedural function or unit of execution that is created or utilized to perform specific tasks based on user queries. Multiple functions can be triggered to generate a complex response. Exemplary functions may include an API Call Function (e.g., for sending a request to an external API to fetch data or perform an action, a Data Processing Function (e.g., for processing input data to perform calculations, transformations, or analysis), a Web Search Function (e.g., for conducting a web search to find external information not available in the current dataset), an Interaction Function (e.g., for communicating with other AI systems or services to exchange information or trigger additional tasks).

In some embodiments, procedural functions 130-134, i.e., individual execution units may include logic-based routines, or task-specific scripts that perform discrete operations. For example, a function may include if/else logic. Such functions would not “learn” from data in the way neural networks do. Instead, they are invoked dynamically based on the identified intents and extracted entities to perform predetermined actions. Unlike neural networks, which are trained models that learn patterns from data, functions that are rule-based or pre-defined are designed to execute specific tasks.

In some embodiments, procedural functions, i.e., individual executions units may use neural network functions that are designed to handle specific tasks associated with the intent. A neural network is a computational model inspired by the way biological neural networks in the human brain process information. It consists of interconnected layers of nodes (neurons) that work together to learn patterns, representations, and relationships in data.

For example, certain content (e.g., unrelated to the topic) might activate a specific neural network node trained to handle functions building dynamic workflows and so on. Similarly, the extracted entities may serve as inputs or parameters for the neural network node. For example, the neural network node handling content moderation would receive additional contextual input such as sentiment predictor data, other user responses, and so on, as inputs to predict the harmful speech. The neural network nodes may be dynamically invoked to manage specific actions such as removing users, creating a chat group for a location, creating a chat group for a location-based event, querying databases, handling updates, or sending notifications, making the system flexible, adaptable, and capable of handling diverse tasks in real time. By utilizing a neural network for a computational model for the procedural function engine allows the engine to learn patterns and make predictions based on data including generating new functions.

In some embodiments, the runtime model 120 may be configured to execute the decisions made by the engine 118, particularly concerning which procedural functions to run and how they should be executed, as illustrated in FIG. 1B. Runtime model 120 may handle the real-time execution of procedural functions based on the intent and entity information provided by models 114 and 116, respectively.

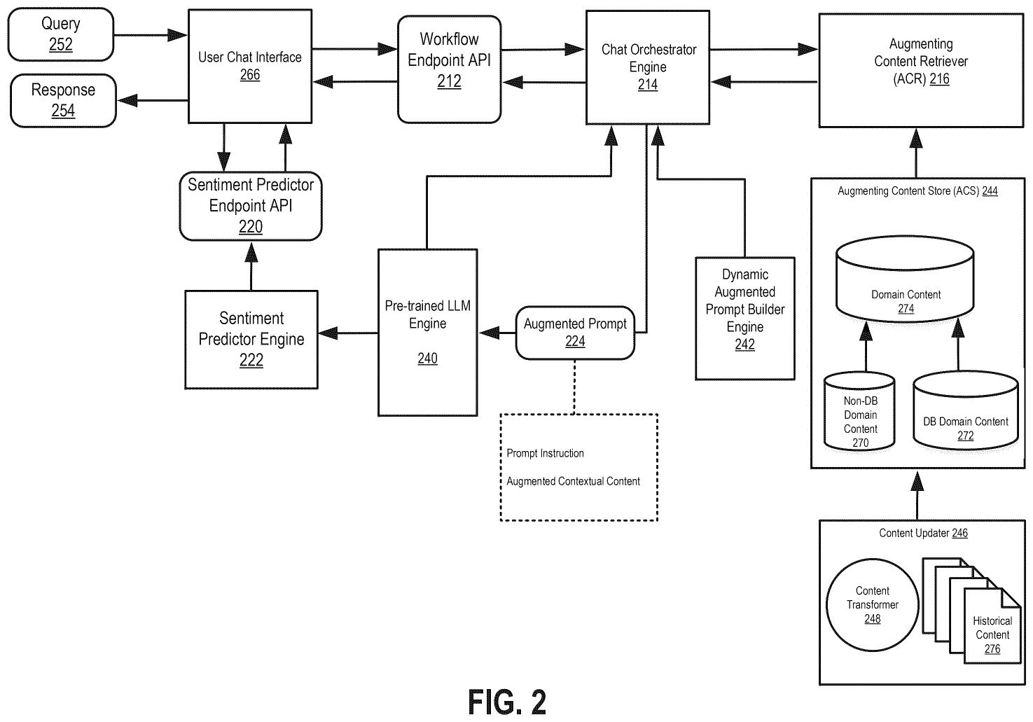

FIG. 2 is an illustrative process for generating a response to a user query using procedural functions generated and executed by the procedural function framework 112, in accordance with some examples described herein. In example 200, a process associated with generating a response is illustrated using various system, including a system comprising a conversation engine. The system executing machine-readable instructions in example 200 may correspond with system 102 in FIG. 1A.

A new query 252 is provided to a user chat interface 266, which may be implemented with a system 102 illustrated in FIG. 1A and may correspond with query interface 166 in FIG. 1A. The user interface is provided for user to input natural language queries or questions.

Chat interface 266 simultaneously sends query 252 to a Q&R endpoint application programming interface (“API”) 212 for question-answering tasks and to a sentiment predictor endpoint application programming interface (“API”) 220 for sentiment detection tasks. The Q&R endpoint API 212 receives the user query from the user chat interface 266 and forwards it to the chat orchestrator engine 214 for processing. Chat orchestrator engine 214 may be a central coordination module that receives user query 252 from the Q&R endpoint API 212 and manages interactions with other system components. Chat orchestrator engine 214 orchestrates the retrieval of relevant content, prompt construction, and activation of the LLM for response generation.

Simultaneously, as the Q&R endpoint API 212 receives the query 252, the sentiment predictor endpoint API 220 also receives user query 252 and forwards the input to a sentiment predictor engine 222.

Sentiment predictor engine 222 utilizes LLM 240 to analyze the sentiment of the user input in “sentiment prediction mode,” by generating a sentiment classification (e.g., “negative” or “non-negative”). The LLM 240 may be a pre-trained LLM and may comprise an open-source large language model (such as OpenChatKit) with generative capabilities, utilizing a generative pretrained transformer (GPT) algorithm. The LLM 240 may be invoked twice: first for sentiment analysis and second for generating a response based on the dynamically constructed prompt, as described herein.

The chat orchestrator engine 214 calls the augmenting content retriever (ACR) engine 216 to find relevant content from the augmenting content store (ACS) 244 using a semantic search engine. For example, the ACR engine 216 uses a semantic search engine (e.g., FAISS) to search for and retrieve content from the ACS 244 that semantically matches the user's query.

The augmenting content store (ACS) 244 serves as a repository of domain-specific content organized for efficient retrieval. As illustrated in FIG. 2, the ACS 244 may include a domain content data store 274, which in some embodiments corresponds to the domain content data store 174 shown in FIG. 1A. The ACS 244 may be pre-populated with private or confidential company data, such as product catalogs, transaction records, or internal manuals, and may also dynamically incorporate content retrieved via API calls, database look-ups, or third-party feeds. In some embodiments, the ACS 244 may further persist workflow definitions or partial workflow contexts generated in response to user queries, allowing the system to resume, adapt, or replay workflows without requiring full regeneration.

The domain content data store 274 may include both structured data 270 and unstructured data 272. Structured data 270 refers to information organized in a defined schema, such as relational databases, NoSQL documents, or tabular datasets. Examples include customer records, transaction histories, inventory lists, or product specifications. This data 270 can be dynamically updated as new records are entered or modified in the underlying business systems.

Unstructured data 272 refers to content stored outside of conventional databases but still relevant to the company or domain. Such content may include documents, manuals, policy guides, emails, presentations, or other file formats (e.g., PDFs, Word documents, JSON, XML). Unstructured data 272 is often semi-structured or free-text in nature and may reside across distributed file systems or intranets. The augmenting content retriever (ACR) 216 performs semantic search across this content, for example using vector-based similarity methods such as FAISS, to identify passages relevant to a user query. Both structured data 270 and unstructured data 272 may be retrieved and integrated into an augmented prompt constructed by the dynamic augmented prompt builder (DAPB) 242. The resulting prompt combines system instructions with contextually relevant content slices, enabling the conversation engine 110 and pre-trained LLM 240 to generate comprehensive, context-aware responses without requiring retraining of the underlying language model. This architecture provides technical improvements over conventional systems by supporting modular, domain-specific augmentation while reducing computational overhead and latency.

In some embodiments, the data in the ACS 244 is continuously updated and maintained with relevant and up-to-date content with a content updater 246. By using content updater 246, ensures that the content is used to enrich the responses generated by the system, ensuring that the answers provided are accurate, current, and contextually relevant.

The content updater 246 collects new data from multiple sources (such as external APIs, databases, real-time feeds, or internal repositories) and integrates this content into the ACS 244. It ensures that the information in the ACS 244 remains fresh and relevant by regularly adding new data and removing outdated or irrelevant information.

The content updater 246 dynamically enhances the knowledge base by incorporating recent, domain-specific content that is pertinent to the user's queries. For example, if the system is used in a business setting, it may retrieve updated policy documents, pricing information, or FAQs that are then stored in the ACS 244 for future use. By keeping the ACS 244 up-to-date, the system is able to generate responses based on the latest available information, enhancing the accuracy and relevance of the answers provided to users.

The content updater 246 integrates with external content sources (such as APIs, web crawlers, or news feeds) and internal databases or knowledge management systems. This allows it to retrieve relevant content in real time, ensuring that the system always has access to the most current data. For example, in an enterprise scenario, content updater 246 may pull data from CRM systems, employee handbooks, or product catalogs to enrich responses to user queries.

Before updating the ACS 244, the content updater 246 preprocesses the content to ensure that it is properly formatted and indexed for fast retrieval. This may include removing irrelevant or sensitive data, parsing and structuring the content in a way that makes it easily searchable, creating metadata tags or labels that improve the accuracy of search results when the system queries the ACS 244. In some embodiments, content transformer 248 is configured in taking raw, unstructured, or semi-structured data (e.g., text, documents, files) retrieved by the content updater 246 from external APIs, internal databases, or other content sources and transforming it into a structured and useful format before it is stored in the ACS 244.

The content updater 246 works closely with the ACR engine 216 to ensure that the content retrieved during user interactions is relevant and up-to-date. The content updater 246 also collaborates with the dynamic augmented prompt builder (DAPB) engine 242 to ensure that the system has access to enriched content that can be used to build detailed and contextually relevant prompts for the LLM 240.

In some embodiments, historical content 276 is used to provide context and enhance the relevance of new content being added by the content updater 246. By referencing past content, the system can maintain continuity and context in responses. Historical content 276 could include previous chat interactions, older versions of documents, or past event data. This helps the system provide consistent answers that reflect both new information and historical trends or patterns. The content updater 246 can reference historical content 276 to identify trends or patterns that inform how new content should be integrated into the ACS 244. For instance, if a pattern of user queries shows increasing interest in a particular product or service, this may influence how content is prioritized and updated. By leveraging historical content 276, the system can predict what type of information might be most relevant based on previous interactions and update the store accordingly. When a user asks a question, the ACR engine 216 may pull both real-time and historical content 276 to ensure that the response is accurate and reflects any updates or changes over time. The content updater 246 ensures that historical and current data are harmonized in the ACS.

The chat orchestrator 214 sends the retrieved content to the dynamic augmented prompt builder (DAPB) engine 242, which may be configured to construct a prompt comprising an instruction and relevant content slices retrieved by the ACR engine 214. For example, the instruction of the prompt constructed by the DAPB engine 242 may comprise the following: “Find answer to the question-what is the minimum score required for your 30-year fixed FHA loan product to purchase a rental property, from the content provided in the next section.” The constructed prompt is forwarded from the DAPB engine 242 to guide the LLM 240 in generating a contextually accurate response.

The response 254 is sent back to the chat orchestrator 214, which forwards it to the Q&R endpoint API 212 for delivery to the user via the chat interface 266.

The components described in FIG. 2 may be initiated as procedural functions of procedural function engine 118 of the conversation engine 110 described above. For example, when a user submits a query (e.g., a query 152 in FIG. 1A or query 252 in FIG. 2), the engine 118 may generate a procedural function to initiate the sentiment predictor engine 222. This function uses the pre-trained LLM 240 in “sentiment prediction mode” to analyze the sentiment of the input. Simultaneously, another procedural function may be generated to activate a chat orchestrator 214, which coordinates with the ACR engine 216 to search and retrieve relevant content from the ACS 244.

Once the relevant content is retrieved, the engine 118 may generate a procedural function to call the DAPB engine 242, which constructs a tailored prompt for the Pre-Trained LLM 240. This prompt combines the user's query with the retrieved content to ensure that the response generated by the LLM 240 is accurate and context specific. The DAPB engine 242 creates an enriched or refined prompt that includes additional context or instructions, which can be fed to the LLM 140 (illustrated in FIG. 1) in the conversation engine 110 to enhance its understanding and improve the quality of the response. The ACR 216 fetches relevant data from various content stores (e.g., knowledge bases, databases such as 174 illustrated in FIG. 1A), which can be incorporated into the LLM's input to provide more comprehensive answers. The sentiment predictor engine 222 output can guide the LLM 240 (and LLM 140 in FIG. 1A) to adjust the tone or style of its responses based on the user's perceived sentiment, ensuring a more empathetic or appropriate reply.

The LLM component 140 in FIG. 1A (in the conversation engine 110) may include architecture that can be designed to take combined inputs from both: its own ecosystem (e.g., classification model 114, extraction model 116, and procedural function engine 118) and the components identified in FIG. 2. For example, the LLM 114 in FIG. 1A might receive enriched prompts that have been dynamically built by combining the output of the classification model 114, extraction model 116 with additional content fetched or generated by the FIG. 2 components described above. Further, the LLM component 140 in FIG. 1A (in the conversation engine 110) can use outputs from FIG. 2, like data retrieved by the ACR engine 216 (in FIG. 2), to answer user queries more accurately by leveraging updated or external data sources. Inputs such as sentiment analysis results or context from the chat orchestrator 214 can be used by the LLM 140 (in FIG. 1A) to adapt its responses to be more relevant and aligned with user expectations.

In some embodiments, some of the engines and/or components in system 102 may be characterized by being synchronous or asynchronous. Synchronous engines and/or components operate in a sequential, blocking manner, meaning they perform their tasks in a specific order and wait for each step to complete before moving on to the next one. These components require an immediate response or result before continuing to the next operation. For example, a synchronous component, waits for the completion of its current task before proceeding to the next task. It does not perform other operations while waiting. Each task is executed in a predefined order, one after another. These components need an immediate result or output from their processes to continue, which can make them more predictable but less flexible in handling multiple tasks simultaneously.

For example, the chat orchestrator engine 214 may operate synchronously to ensure that it sequentially coordinates all steps necessary for generating a response. It may wait for the ACR engine 216 to finish retrieving content before moving to the next step (e.g., such as passing content to the dynamic augmented prompt builder (DAPB) 242). DAPB engine 242 in turn constructs a prompt for the LLM 240 based on the content retrieved. DAPB engine 242 operates synchronously in that it waits for all necessary content to be available before creating and forwarding the prompt to the LLM 240. Finally, LLM 240 may be invoked synchronously to generate a response based on the constructed prompt, meaning that the system waits for the LLM 240 to complete its generation task before continuing to the next process.

By contrast, asynchronous components operate in a non-blocking manner, meaning they initiate tasks that run independently and do not wait for those tasks to complete before moving on to other operations. These components can handle multiple tasks concurrently and do not require immediate responses to continue processing. For example, an asynchronous component does not wait for a task to complete before starting another task. It can handle multiple tasks simultaneously. Tasks can be executed in parallel or independently, allowing for more flexible and efficient use of system resources. Often, asynchronous modules use event-driven mechanisms or callbacks to handle tasks once they are completed.

In some embodiments, sentiment predictor engine 222 may be configured to operate asynchronously, allowing the sentiment predictor endpoint API 220 to send the user's input to the LLM 240 in a “sentiment prediction mode” without blocking other processes (like content retrieval or prompt construction). Once the sentiment analysis is complete, the result can be asynchronously passed back to the relevant module or process. The ACR engine 216 may be configured to perform content retrieval asynchronously, enabling the system to start retrieving content from the ACS 244 while other tasks are being processed in parallel. This can speed up the overall workflow by ensuring that content retrieval does not block other tasks.

Synchronous operations (e.g., chat orchestrator engine 214, DAPB engine 242, and/or LLM 240) ensure that critical steps requiring a defined sequence (like prompt construction and LLM response generation) are executed in order, maintaining coherence and accuracy in the response. Asynchronous operations (e.g., ACR engine 216 and/or ACS 244) allow the system to perform background tasks (like sentiment detection or content retrieval) concurrently, reducing delays and optimizing overall processing time. By virtue of combining both types of modules allows the system to optimize performance, ensuring accurate and context-aware responses while maintaining efficiency and scalability.

AI drift occurs when a machine learning model's performance degrades over time due to changes in the underlying data distribution or evolving user behavior and requirements. This can lead to inaccuracies in the model's predictions or outputs, necessitating frequent retraining to maintain performance. The described system 102 minimizes or eliminates AI drift by using a well-trained, pre-trained LLM 140 (and LLM 240 in FIG. 2) that is robust and comprehensive in its understanding of natural language. Instead of relying on the LLM to store domain-specific knowledge that may change over time, the system dynamically retrieves the most relevant and up-to-date content at runtime using ACR engine 216 and ACS 244 illustrated in FIG. 2. By decoupling the LLM 140 and/or 240 from domain-specific content that might evolve, the system ensures that the LLM 140 and/or 240 remains effective over time without the need for retraining. The LLM 140 and/or 240 generates responses based on dynamically retrieved content, which is always current, thus preventing drift caused by outdated information. The system 102 maintains high accuracy in its outputs by continuously using up-to-date domain-specific content without modifying the core LLM 140 and/or 240.

Since the LLM 140 and/or 240 does not directly handle evolving content, its understanding of language remains consistent, avoiding drift and ensuring stable performance. Eliminating AI drift reduces the need for ongoing monitoring, evaluation, and correction of model performance, resulting in lower maintenance overhead.

In traditional AI and machine learning systems, retraining is required whenever there is a significant change in domain-specific content or user behavior. Retraining an LLM is a resource-intensive process that requires substantial computational power, time, and data. It also involves high costs associated with cloud infrastructure, storage, and human resources.

The disclosed system 102 avoids the need for retraining by leveraging a pre-trained, generic LLM 140 and/or 240 combined with a dynamic content retrieval approach. Instead of embedding domain-specific knowledge directly within the LLM 140 and/or 240, the system 102 dynamically retrieves relevant content from the ACR engine 216 and ACS 244, illustrated in FIG. 2, and feeds this content to the LLM 140 and/or 240 at runtime. The conversation engine 110 dynamically generates procedural functions that guide the retrieval of up-to-date content and construct enriched prompts for the LLM 140 and/or 240, ensuring that the LLM 140 and/or 240 always operates with the most relevant information without requiring any updates to its core training.

By eliminating the need for frequent retraining, the system significantly reduces computational costs and energy consumption. It avoids the expenses associated with the infrastructure and human resources required for training large-scale models. The conversation engine 110 can easily scale across different domains and datasets without the overhead of retraining. New data sources and business scenarios can be integrated by updating the content retrieval mechanisms rather than modifying the LLM 140 and/or 240 itself. The system 102 remains lightweight and efficient, using minimal CPU and GPU resources. The pre-trained LLM 140 and/or 240 does not need to be retrained, which makes the architecture suitable for real-time applications where low latency and quick response times are crucial. The system 102 can rapidly adapt to changes in domain-specific content or user needs by updating the content in the ACS 244 illustrated in FIG. 2 rather than retraining the LLM 140 and/or 240. This allows the system to handle dynamic and evolving business requirements efficiently.

As alluded to above, a workflow may consist of a series of steps or stages that are necessary to fulfill the user's intent. When a user submits an initial query, such as “I want to apply for a mortgage loan,” the conversation engine 110 activates the classification model 114 to determine the user's intent. The classification model 114 recognizes the intent as “apply for a mortgage loan” and dynamically generates a corresponding workflow for this task (i.e., a loan application). Unlike conventional scripted workflows, the disclosed system generates procedural functions on demand, enabling adaptive branching, reordering, and pausing of workflows. These procedural functions (cells) interact with the user, capture required information, and validate responses in real time.

The extraction model 116 is invoked to determine the specific parameters (or entities) required for each step of the workflow. For example, after identifying the intent to apply for a mortgage loan, the extraction model 116 may recognize that the user's name, employment status, income, property address, and other details are necessary parameters to collect. These parameters populate the workflow context so that subsequent steps are dynamically customized rather than pre-scripted.

As the user proceeds through the workflow, the extraction model 116 dynamically determines which questions to ask next based on the user's previous responses and the requirements of the selected workflow. The classification and extraction layers work together with the procedural function engine 118 to ensure that workflows progress logically while adapting to incomplete, ambiguous, or unexpected user input.

For instance, if the user provides an incomplete answer (e.g., “I am employed”), the extraction model 116 may prompt further clarifying details (“What is your current job title?” or “What is your monthly income?”). This adaptive refinement capability provides more robust data collection than conventional fixed workflows.

The conversation engine 110 continuously monitors workflow progress to ensure that all necessary information is collected in a logical sequence. The system provides real-time feedback to the user, confirming receipt of information, requesting clarifications, or offering guidance. By maintaining only minimal workflow state metadata (e.g., sequence identifiers), the architecture supports a stateless design that allows workflows to be paused, resumed, or run concurrently with minimal storage overhead.

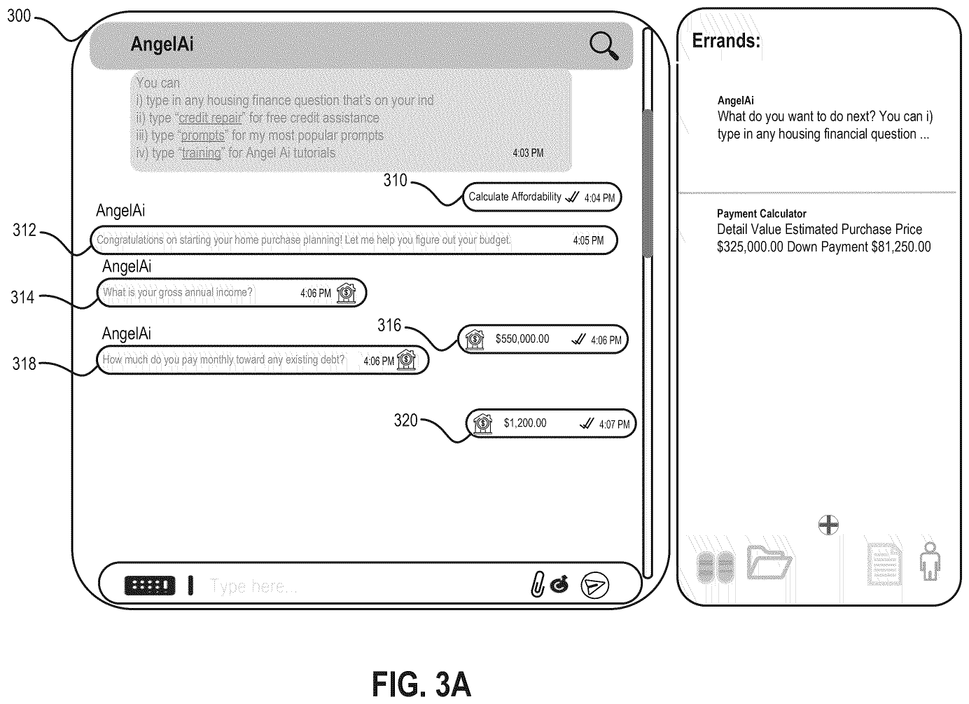

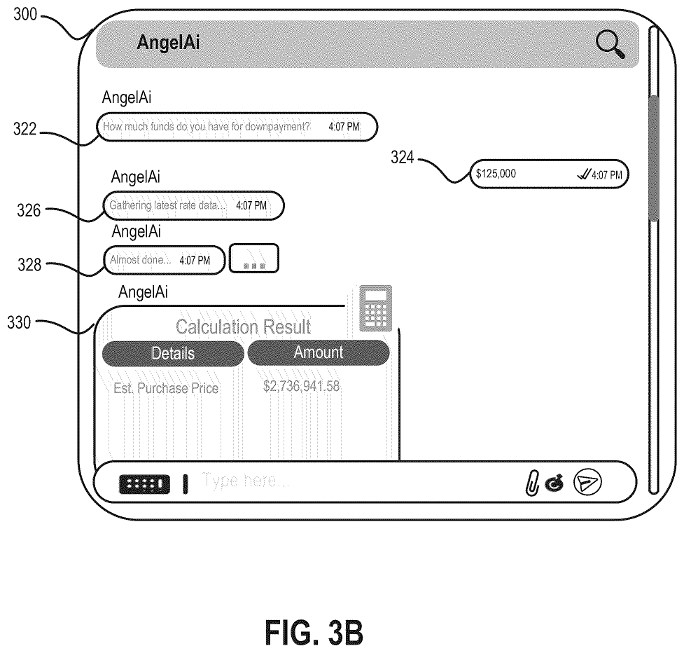

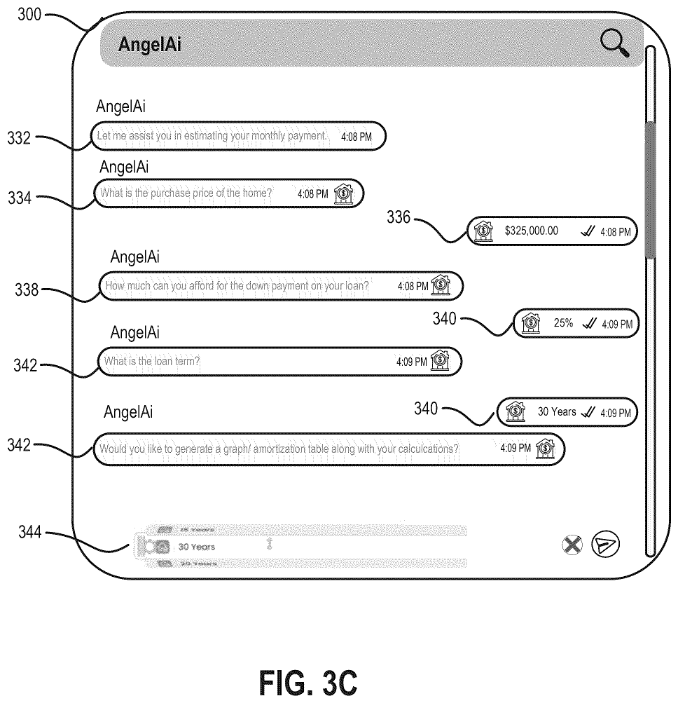

FIGS. 3A-3C illustrate exemplary chat-based user interfaces of the context-aware, domain-specific system for generating workflow-based responses, according to an implementation of the disclosure.

In FIG. 3A, a user enters a request 310 (“Calculate Affordability Request”) within a chat-based interface 300. In response, the system generates a confirmation message 312 acknowledging the initiation of the affordability workflow. The system then presents a workflow question 314 (“What is your gross annual income?”), and the user provides a corresponding response 316 (“$550,000.00”). The system continues the workflow by presenting a subsequent question 318 (“How much do you pay monthly toward any existing debt?”), and the user provides a corresponding response 320 (“$1,200.00”). These interactions illustrate how the system adaptively structures multi-step processes without pre-defined scripts, capturing user responses in real time and integrating them into the workflow context.

In FIG. 3B, within the chat interface 300, the system presents a workflow question 322 (“How much funds do you have for downpayment?”). The user provides a corresponding response 324 (“$125,000”). Based on this input and previously gathered parameters, the system generates intermediate confirmation messages 326 (“Gathering latest rate data . . . ”) and 328 (“Almost done . . . ”). The system then generates a calculation result 330, which is displayed in a dedicated graphic widget showing an estimated purchase price. This illustrates how the architecture integrates domain-specific computations into conversational workflows in real time, providing immediate and context-aware feedback to the user.

In FIG. 3C, within the chat interface 300, the user initiates a “Payment Calculator” workflow. The system provides an introductory message 332 (“Let me assist you in estimating your monthly payment”) and then presents workflow questions 334, 338, and 342 to collect required parameters such as purchase price, down payment, and loan term. The user provides corresponding responses 336 (“$325,000.00”) and 340 (“25%” and “30 Years”). The loan term may also be selected using a graphical wheel widget 344, demonstrating how procedural functions support adaptive graphical inputs within the conversational interface. Unlike conventional static calculators, the disclosed system dynamically orchestrates these inputs into a cohesive workflow, which can be paused, resumed, or combined with other workflows.

The system is capable of managing multiple workflows simultaneously. If the user initiates a new workflow (e.g., “I want to apply for a credit card” or “I want to make a dinner reservation”) while still in the middle of another workflow (such as a mortgage loan application), the conversation engine 110 dynamically pauses the current workflow and activates a new workflow based on the newly detected intent.

The classification model 114 identifies the new intent (e.g., “apply for a credit card” or “make a dinner reservation”) and generates a corresponding workflow. For a credit card application, the workflow may include questions such as: “What is your name?” “What is your annual income?” “Do you have any existing credit cards?” Similarly, for a dinner reservation, the workflow may include questions such as: “What is your preferred date and time?” “How many guests?” “Do you have any special dietary requirements?” The original mortgage loan workflow is preserved in its current state, with collected information and position stored as lightweight metadata. The new workflow is then initiated, and the user is guided through it step-by-step without losing the ability to return to the previous workflow.

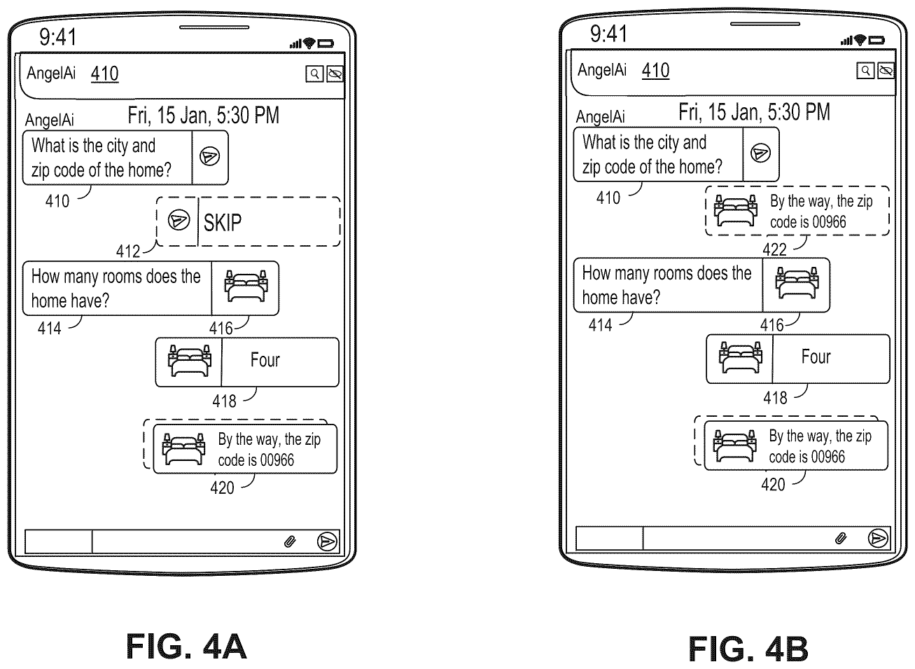

FIGS. 4A-4B illustrate how the system automatically detects responses and places them into the correct workflow sequence. In FIG. 4A, the system presents a question 410 (“What is the city and zip code of the home?”). The user enters a response 412 (“SKIP”), prompting the conversation engine to proceed with further questions 414 (e.g., “How many rooms does the home have?”) without requiring the skipped input. The question 414 may include a graphic element 416, such as an icon representing a bedroom. The user then provides a response 418 (“Four”) and later provides an additional response 420 (“By the way, the zip code is 00966”). The system analyzes the delayed input and determines that response 420 corresponds to the earlier skipped question 410.

As shown in FIG. 4B, the conversation engine automatically associates the late-provided response 422 with the original question 410, effectively replacing the placeholder skip with valid data. This capability improves robustness by allowing the workflow to continue smoothly even when users skip or delay answers, and ensures that all parameters are ultimately captured in the correct sequence without requiring the workflow to restart.

At any point, if the user decides to return to a previously paused workflow (e.g., “Oh, I now remembered my zip code is 00966”), the classification model 114 recognizes the user's intent to resume the earlier workflow.

In one embodiment, the system 102 is stateless, meaning it does not persist the entire workflow state but instead retains only minimal metadata such as the sequence identifier and the total number of steps. For example, if a workflow consists of five steps and the user paused at step 3 (“What is your zip code?”), the system recalls that sequence number without storing all prior responses. This lightweight approach enables seamless resumption of the workflow from the correct point.

When resuming, the conversation engine 110 dynamically reconstructs the context based on the user's most recent inputs and the stored sequence number. The user is prompted to provide the required information for the current step (e.g., “What is your zip code?”), and the workflow continues logically through the remaining stages. If the user chooses to switch to a different workflow midstream, the system records the sequence number of the interrupted workflow and activates the new one. Upon returning, the paused workflow resumes from the stored step without loss of context or data.

The stateless design eliminates the need to store comprehensive workflow states, thereby reducing storage and memory requirements and simplifying architecture. By remembering only sequence numbers and total step counts, the system avoids synchronization errors common in stateful systems and scales efficiently across cloud and distributed environments. This enables the system to support a large number of concurrent users and workflows without significant resource overhead.

The stateless design further improves adaptability: if workflows are updated or modified, the system regenerates context dynamically rather than requiring migration of stored state data. In the event of a failure or disruption, workflows can be resumed using the last known sequence number, reducing the risk of losing progress. These improvements collectively yield a more reliable, scalable, and fault-tolerant architecture compared to conventional workflow systems.

In some embodiments, the system 102 is further configured to iteratively generate new workflows at runtime based on evolving user input, external data updates, or dynamically changing business logic. Unlike conventional systems that rely on pre-scripted, rigid task flows, the disclosed conversation engine 110, working in conjunction with the classification model 114, extraction model 116, and procedural function engine 118, can synthesize entirely new workflow sequences without manual reprogramming. Each newly generated workflow may incorporate questions, graphic widgets, or procedural functions that were not predefined but instead created dynamically in response to contextual signals such as a user skipping a step (FIG. 4A), providing delayed input (FIG. 4B), or introducing a new intent midstream.

For example, when a user begins with an affordability calculation (FIG. 3A) and later requests a payment calculator (FIG. 3C), the system dynamically stitches the workflows together by generating a new composite flow that includes both sets of steps in a logical order. This iterative workflow generation may also adapt in real time as new content is retrieved from augmenting content store 244, or as new domain-specific rules are introduced (e.g., updated mortgage eligibility thresholds). The procedural function engine 118 can generate new “cells” that reference such rules, allowing the workflow to immediately adapt without requiring retraining of the LLM 140 or redeployment of the system.

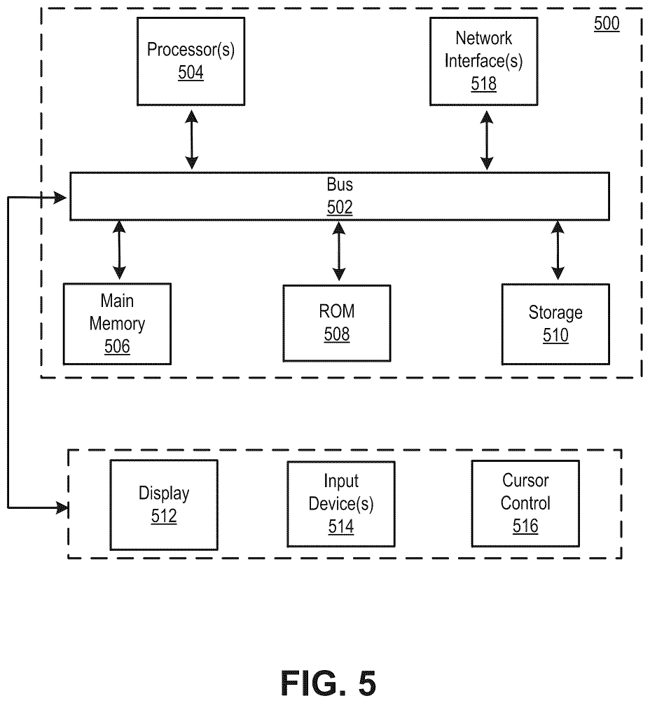

In certain embodiments, the dynamically generated workflow may also incorporate user-specific metadata, such as prior interaction history or sentiment classification results, to create personalized workflow paths. This ensures that repeat users are not required to re-enter the same information and that workflows adapt to their prior behavior. The iterative workflow generation process therefore provides a technical improvement over traditional workflow engines by enabling real-time customization, stateless resumption, and automatic adaptation to new contexts, resulting in more accurate, efficient, and user-friendly task completion.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 5. Various embodiments are described in terms of this example computing module 500. After reading this description, it will become apparent to a person skilled in the relevant art how to implement the technology using other logical circuits or architectures.

FIG. 5 illustrates an example computing module 500, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 5. Various embodiments are described in terms of this example-computing module 500. After reading this description, it will become apparent to a person skilled in the relevant art how to implement the application using other computing modules or architectures.

Referring now to FIG. 5, computing module 500 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally. The bus 502 may also be connected to other components such as a display 512, input devices 514, or cursor control 516 to help facilitate interaction and communications between the processor and/or other components of the computing module 500.

Computing module 500 might also include one or more memory modules, simply referred to herein as main memory 506. For example, preferably random-access memory (RAM) or other dynamic memory might be used for storing information and instructions to be executed by processor 504. Main memory 506 might also be used for storing temporary variables or other intermediate information during execution of instructions to be executed by processor 504. Computing module 500 might likewise include a read only memory (“ROM”) 508 or other static storage device 510 coupled to bus 502 for storing static information and instructions for processor 504.

Computing module 500 might also include one or more various forms of information storage devices 510, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 510 might include other similar instrumentalities for allowing computer programs or other instructions or data to be loaded into computing module 500. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 500.

Computing module 500 might also include a communications interface or network interface(s) 518. Communications or network interface(s) interface 518 might be used to allow software and data to be transferred between computing module 500 and external devices. Examples of communications interface or network interface(s) 518 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 518 might typically be carried on signals, which can be electronic, electromagnetic (which includes optical) or other signals capable of being exchanged by a given communications interface. These signals might be provided to communications interface 518 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 506, ROM 508, and storage unit interface 510. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method, comprising:
receiving a query from a first client;
initiating a classification process of the query that generates an action attribute for the query;
initiating an extraction process of the query that generates a parameter attribute for the action attribute of the query;
initiating a plurality of parameter functions based on the parameter attribute that generates at least one or more outputs; and
generating, using a large language model (LLM), a response to the query using the action attribute generated by the classification process, the parameter attribute generated by the extraction process, and the one or more outputs generated by the plurality of parameter functions;
wherein the outputs generated by the plurality of parameter functions comprise generating a sentiment classification, generating semantically similar content, and generating a dynamically constructed prompt.

2. The computer-implemented method of claim 1, wherein generating the sentiment classification comprises initiating a sentiment classification process that uses the LLM to generate a sentiment for the query.

3. The computer-implemented method of claim 1, wherein generating semantically similar content comprises initiating a semantic search engine that obtains semantically similar content to the query from a content specific data store.

4. The computer-implemented method of claim 1, wherein generating the dynamically constructed prompt comprises using the semantically similar content generated by initiating the semantic search engine.

5. The computer-implemented method of claim 1, wherein the classification process and the extraction process of the query each comprise an artificial intelligence (AI) model, wherein the AI model is trained using labeled domain-specific data.

6. The computer-implemented method of claim 1, wherein the LLM comprises a pre-trained LLM and a Generative Pretrained Transformer (GPT).

7. The computer-implemented method of claim 1, wherein the action attribute of the query specifies an intent of a user, wherein the user is associated with the client.

8. The computer-implemented method of claim 7, wherein the parameter attribute of the query specifies a set of parameters associated with the intent of the user.

9. The computer-implemented method of claim 1, wherein the response comprise a set of workflow questions generated based on the action attribute of the query for completing a task.

10. A system comprising:
one or more computing processors; and
a machine-readable storage medium storing instructions that, when executed by the one or more processors, cause the system to:
receive a query from a client;
initiate a classification process of the query that generates an action attribute for the query;
initiate an extraction process of the query that generates a parameter attribute for the action attribute of the query;
initiate a plurality of parameter functions based on the parameter attribute that generates at least one or more outputs; and
generate, using a large language model (LLM), a response to the query using the action attribute generated by the classification process, the parameter attribute generated by the extraction process, and the one or more outputs generated by the plurality of parameter functions;
wherein the outputs generated by the plurality of parameter functions comprise at least a sentiment classification, a semantically similar content and a dynamically constructed prompt.

11. The computer system of claim 10, wherein the sentiment classification comprises initiating a sentiment classification process that uses the LLM to generate a sentiment for the query.

12. The computer system of claim 10, wherein the semantically similar content comprises initiating a semantic search engine that obtains semantically similar content to the query from a content specific data store.

13. The computer system of claim 10, wherein the dynamically constructed prompt comprises the semantically similar content generated by initiating the semantic search engine.

14. The computer system of claim 10, wherein the classification process and the extraction process of the query each comprise an artificial intelligence (AI) model, wherein the AI model is trained using labeled domain-specific data.

15. The computer system of claim 10, wherein the LLM comprises a pre-trained LLM and a Generative Pretrained Transformer (GPT).

16. The computer system of claim 10, wherein the action attribute of the query specifies an intent of a user, wherein the user is associated with the client.

17. The computer system of claim 16, wherein the parameter attribute of the query specifies a set of parameters associated with the intent of the user.

18. The computer system of claim 10, wherein the response comprise a set of workflow questions generated based on the action attribute of the query for completing a task.
